(19) United States
(12) Patent Application Publication
(10) Pub. No.: US 2005/0212956 A1
(43) Pub. Date: Sep. 29, 2005

(54) Main illuminant judging method in multi-light environment

(76) Inventors: Ming-Kai Liao, Kaohsiung City (TW); Chung-Kun Wu, Sanchong City (TW)

Correspondence Address: PERKINS COIE LLP;PATENT-SEA, P.O. BOX 1247, SEATTLE, WA, 98111-1247, US

(21) Appl. No.: 10/811,027

(22) Filed: Mar. 26, 2004

(51) Int. Cl. H04N 5/238

(52) U.S. Cl. 348/366

(57) ABSTRACT

The present invention measures a variability of a light source according to the relationship of the different brightness at different time points, to determine whether the light source has a periodic brightness. A suitable exposure time can be determined in accordance with the determined result that if the variability of a light source is within a tolerant range.

### TECHNICAL FIELD

This invention relates to a method determination of light source within a light source environment, and more particularly to the method for main illuminant determination under multi-light environment.

### BACKGROUND

The development of camera is from mechanical camera, automatic camera, until digital camera in recent year. The developing of automatic camera art really brings convince for people to use. The users just need to turn the camera on if they like to record their preferred images down. The camera will automatically focus and decide a shutter speed and aperture value of a suitable live for light source brightness, which would make the film (or electric film as CCD, CMOS sensor) exposure adequately. Under the fully automatic design of camera, the cameras now are really easy to use. In other words, the users do not need to understand the theory of camera and its exposure composition of shutter speed and aperture value, and use the camera easily.

The main function of camera is to capture the images, let the user retain and memorize their beautiful images. Therefore, the objective of the camera is to record any viewable images. However, the camera of sensing theory is not the same at all with what our eyes visualize. Due to the physical restriction on the color of feeling and sensitization velocity, so that we hoodwink easily. For example, the television (TV) or movie to use a replacement method of 24 or 30 frames in every second, which makes us hard to determine the frame is playing one by one, and thought the images we saw on the TV are in sequence. However, the camera will truly record every signal of light captured during the opening time of shutter. For instance, every single frame appear on TV is scanned sequentially by electron gun. If the shooting time is shorter than the time of a frame scanning by electron gun, the images were shot on TV would only displaying partial images, which is not a complete images as what our eyes really visualize.

Besides, the indoor is under circumstance of light bulb or incandescent lamp for example. The power of light bulb or incandescent lamp is alternating current (AC) as FIG. 1a shown, the voltage value may have periodic vibration and the vibration period will different following with various countries, 50 Hz or 60 Hz are mainly the two kinds. Therefore, the white light or incandescent lamp have two peak values of voltage, so having two times flicker in every period, and there is flickering 100 or 120 times secondly. However, our eyes can not sense such flicker frequency easily.

However, the captured images instrument if it's captured image timing (shutter timing) is not integer times of vibration period (n/100 second or n/120 second, n is integer), its images capture may be more dark or more bright. As FIG. 1b has shown, 100 is the brightness of light source within periodic vibration. The oblique line regions of A and B are signal accumulative value (the size of area) at different time points. It is obvious to visualize from the FIG. 1b, the images may be too bright at the region A, and it may be too dark at the region B. There will be a huge different between the captured images and what our eyes have really seen. Therefore, these kinds of images must be unaccepted by the user.

If the shutter time is an integer times of the period, and the emitting brightness (the size of area) is the same in a periodic time, then the accumulative brightness (the size of area) we obtained will be the same at whatever time points we start to shoot. In this way, the captured images are exactly the same as what our eyes really seen.

A general method determination of light source only determines the existences of artificial light source. However, there are light source in a general environment. Among the mixing light source, the main light source is not artificial light source, while not to use as n/100 or n/120 (n is integer) of shutter speed to shoot, the images brightness will be a little difference within a brightness of tolerable range of a general film or electric film. This means the resolution or color of images we obtained is very close to the images under exposure adequately. Therefore, we still can obtain the right or suitable image under such circumstance. While the main light source is not artificial light source and using the shutter speed as n/100 or n/120 is unnecessary, we could use other shutter speed to do exposure instead. Therefore, when the user needs to use the faster shutter speed to capture sport images or to use larger aperture value (adjusting the shutter speed in order to obtain the same exposure) to capture the shorter depth of field status, we can directly use the shutter speed difference from n/100 or n/120 to capture.

According to the explanation mentioned above, in the conventional arts, the shutter speed of camera is base on only a predetermined combination of shutter speed and aperture value, and without considering the type of light source. It may be just determined if the light source is artificial or stable light source, and not considered the status of multi-light source. This would cause the problem that only if light source with periodic variance, then the light source is determined as an artificial light source in terms of restrain the adjustable range of shutter speed or aperture value of camera.

### SUMMARY

Therefore, the present invention has been made in view of the above problems in the prior arts, and it is an objective of the present invention to provide the method determination of main light source under the circumstance of multi-light sources. This can help to determine shutter speed (exposure time) more appropriately and accurately.

Another objective of the present invention is to use the characteristic of CMOS sensor device to determine main light source during capturing one frame under the circumstance of multi-light source environment.

Still another objective of the present invention is to measure the brightness of light source of environment at different time points for deciding the variance period of artificial light source.

A furthermore objective of the present invention is to display flicker-free images on a monitor of the captured images instrument.

The present invention also provides a method determination of main light source under the circumstance of multi-light sources. The method determination mention above comprising the steps of using a sensor device at the at least two light sensor region at different time points to measure and obtain at least two illuminations value of an light source environment; and according to the at least two illuminations value to determine a main light source under the circumstance of light source environment.

The present invention provides a method determination of main light source under the circumstance of multi-light sources as well. The method determination mention above comprising the steps of using a light sensor device to measure at least two illumination values of light source of environment at different time points and determining a main light source of the environment according to the at least two illumination values.

Therefore, in accordance with the method determination of main light source under the circumstance of multi-light of the present invention, the brightness variance of a light source of environment is determined whether it is within the range of tolerable variance, and then uses it as a reference for selecting time exposure. Moreover, the light sensor device is accordance with the time exposure to capture images data to the monitor of images capture instrument. This can make the images flicker-free displaying on the monitor.

### BRIEF DESCRIPTION OF THE DRAWINGS

The foregoing aspects and many of the attendant advantages of this invention will become more readily appreciated as the same becomes better understood by referring to the following detailed description, when taken in conjunction with the accompanying drawings, wherein:

FIG. 1a is a schematic diagram of periodic variance of brightness of artificial light source;

FIG. 1b is a schematic diagram of accumulative exposure volume of at different time points under the circumstance with periodic brightness;

FIG. 2 is a schematic diagram of a preferred determinative flow chat of main light source under the circumstance of multi-light source in the present invention;

FIG. 3 is a schematic diagram of another preferred determinative flow chat of main light source under the circumstance of multi-light sources of the present invention; and

FIG. 4 is a schematic diagram of main light source is a stable light source under the circumstance of multi-light source.

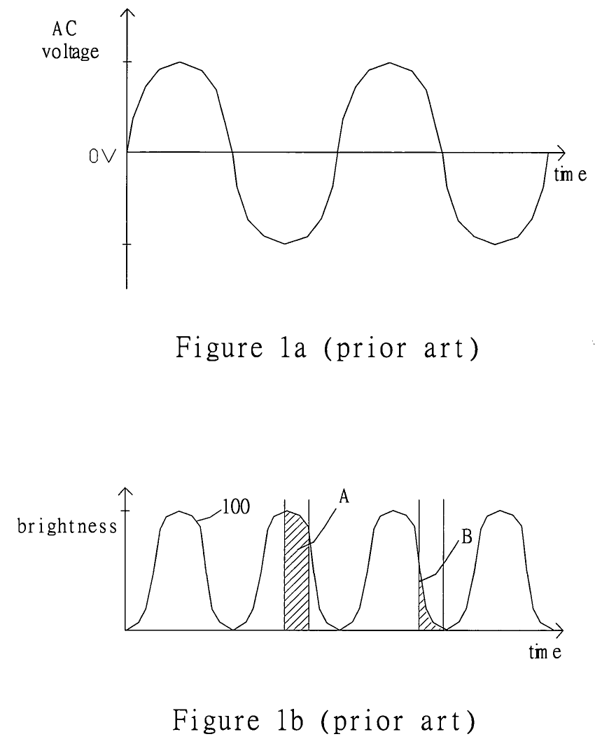

### DETAILED DESCRIPTION

Some embodiment's sample of the invention will now be described in greater detail. Nevertheless, it should be recognized that the present invention can be practiced in a wide range of other embodiments besides those explicitly described, and the range of the present invention is expressly not limited except as specified in the accompanying claims.

Then, the components of the different elements are not shown to scale. Some dimensions of the related components are exaggerated and meaningless portions are not drawn to provide a more clear description and comprehension of the present invention.

The spirit of the present invention is to use the different time points to measure the brightness of light source environment. It is for determining if the main light source is stable light source (as natural light source) or flickery light source (as incandescent lamp or white light) under the multi-light source. While the main light source is stable light source, the length of time exposure of the light sensor device in the image capture instrument (camera, video camera and so on) can be any value, and not subject to the integer times of period of light source with varying brightness to eliminate over exposure, short exposure or the image flicker problem. For example, while the alternating current (AC) with 60 Hz or 50 Hz is the power, then the brightness variance frequency of incandescent lamp or white light is two times, its period is 1/120 second or 1/100 second.

In other words, although light source of the environment has periodic brightness variance, the variance is within the brightness of tolerable range of light sensor device, and then the light source of environment can be viewed as stable light source. While a brightness variance exceeds the tolerable range of brightness of the light sensor device, then the light source of environment needs to be viewed as artificial light source (or flickery light source), and the length of time exposure of the light sensor device further needs to be adjusted to be integer times of the period.

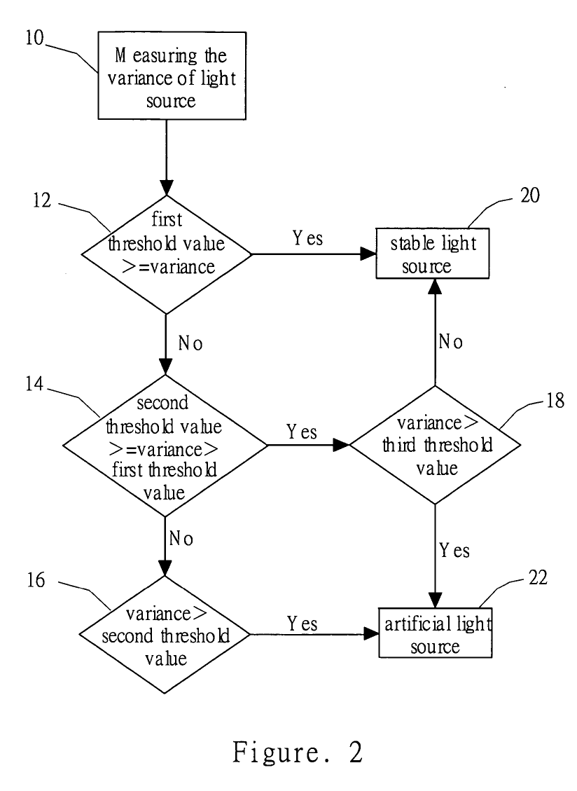

FIG. 2 is a preferred determinative flow chart of the present invention. First of all, step 10 is to measure the variance of light source of environment. Step 12 is to measure whether light source of environment is a stable light source 20 or an unstable light source. Its determinative method is while the variance of light source of environment is smaller than or equal to a first threshold value, then light source of environment is determined as a stable light source 20, if not, then light source of environment is determined as an unstable light source. This first threshold value is the greatest brightness variance of stable (or natural) light source under a general environment. If the variance of light source exceeds the greatest value of a brightness variance of stable (or natural) light source, then light source of environment is determined unstable light source.

When the light source of the environment is determined as an unstable light source according to step 12, step 14 is to determine whether the light source of environment is an artificial light source (or a light source with a periodic brightness) or a mixing light source. Its determinative method is while the variance of light source of environment is greater than the first threshold value, and smaller than or equal to a second threshold value, and then the light source of environment is determined as a mixing light source.

When step 14 is to determine light source of environment is not a mixing light source, step 16 then is to determine whether it is or is not artificial light source 22. Its determinative method is while the variance of light source of environment is greater than a second threshold value, and then the light source of environment is determined as an artificial light source 22. The second threshold value is the smallest value of a brightness variance in the artificial light source under a general environment. Therefore the light source of environment is determined as artificial light source 22 if it exceeds the smallest brightness variance of artificial light source. However, if the brightness variance of environment is between the first threshold value or natural light source second threshold value, then the light source of environment must include a light source with periodic brightness and a stable light source to make the mixing brightness variance to lie in the between first threshold value and second threshold value.

When a light source environment is determined as mixing light source, and the mixing light source needs further to be determined whether it is a stable light source 20 or an artificial light source 22. The determinative method depends on the brightness tolerable range of light sensor device. Therefore, step 18 is to determine whether it can be viewed as a stable light source 20 or not according to whether the variance of light source of environment is greater, and smaller than or equal to a third threshold value. While the brightness variance is smaller than or equal to the third threshold value, then it is determined as a stable light source 20. While the brightness variance is greater than the third threshold value, then it is determined as an artificial light source 22.

In the determinative flow process mentioned above, the preferred determinative equations of variance under as equation 1 and equation 2 have shown respectively.

Equation 1 (the variance of light source environment):

$$Variance = {\sum }_{n = 0}^{N} \vert Y [ n ] - Y [ n + 1 ] \vert$$

Equation 2 (the variance ratio of light source environment):

$$Variance ratio = {\sum }_{n}^{N - 1} ( \vert Y [ n ] - Y [ n + 1 ] \vert / min ( Y [ n ] , Y [ n + 1 ] ) )$$

Wherein Y(n) is a brightness value of environment the nth of time points, and wherein N is greater than 2.

The equations mentioned above are to use the brightness difference and variance ratio (alterant ratio) of light source of environment to inflict and determine main light source. The main light source can directly be determined by the variance ratio of light source of the environment, so it is unnecessary to use two determined values as variance and variance ratio.

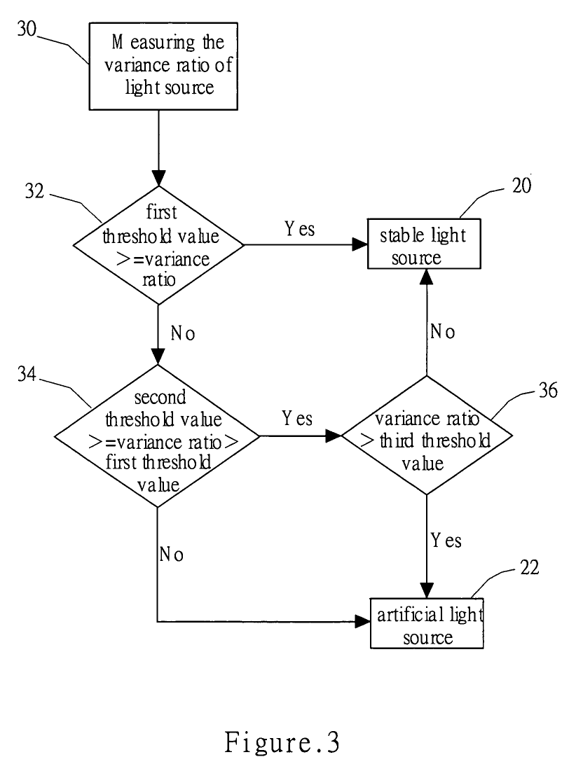

FIG. 3 is another preferred determinative flow chart of the present invention. Firstly, step 30 is to measure variance ratio of light source of the environment. Step 32 is to determine whether light source of environment is a stable light source 20 or an unstable light source. The determinative method thereof is when the variance ratio of light source of environment is smaller or equal to a first threshold value, and then the light source of environment is determined as a stable light source, if not, then the light source of environment is determined as an unstable light source. This first threshold value is the greatest brightness variance of stable (or natural) light source under a general environment. Therefore, it exceeds the greatest value of a brightness variance under the stable light source, and then the light source of environment is determined as an unstable light source.

When step 32 is to determine light source of environment is an unstable light source, step 34 is further to determine whether the light source of environment is an artificial light source (or light source under the variance of periodic brightness) or a mixing light source. The determinative method thereof is when the variance ratio of light source of environment is greater than a second threshold value, light source of environment is determined as an artificial light source 22, if it is not, then light source of environment is determined as a mixing light source. This second threshold value is the smallest value of brightness variance under the artificial light source under a general environment. Therefore, it exceeds the smallest brightness variance of artificial light source, and then the light source of environment is determined as artificial light source 22. However, if the variance of light source of environment is measured between first threshold value and a second threshold value, then the light source of environment must include light source of periodic variance and stable light source to make the mixing brightness variance to lie in between first threshold value and second threshold value.

While determines light source of environment as a mixing light source, then needs to determine whether mixing light source is a stable light source 20 or an artificial light source 22. The determinative method thereof needs to depend on the tolerated range of brightness variation of light sensor device. Therefore, step 36 is according to whether the variance of light source of environment is greater or smaller than a third threshold value for determining whether the light source of environment can be or can not be viewed as a stable light source 20. While the variance ratio of brightness under the light source of environment is smaller than or equal to third threshold value, then it is determined as a stable light source 20. While the variance ratio of brightness under the light source of environment is greater than third threshold value, then it is determined as an artificial light source 22.

The determinative flow process mentioned above, a preferred determinative method of variance ratio under the light source of environment is shown as equation 3.

Equation 3 (the variance ratio of light source of environment):
Variation-ratio=(max(Y[1],Y[2], . . . ,Y[N])−min(Y[1],Y[2], . . . ,Y[N]))/min(Y[1],Y[2], . . . ,Y[N])

Wherein, Y[n] is the measurement of brightness environment value at the nth of time points, and N is greater than 2.

The equation mentioned above is solely a preferred determinative equation. For example, the denominator of equation 3 is min(Y[1], Y[2], . . . ,Y[N], which is the measurement of smallest value of brightness however it can be changed as taking the greatest value or some measurement of brightness value out.

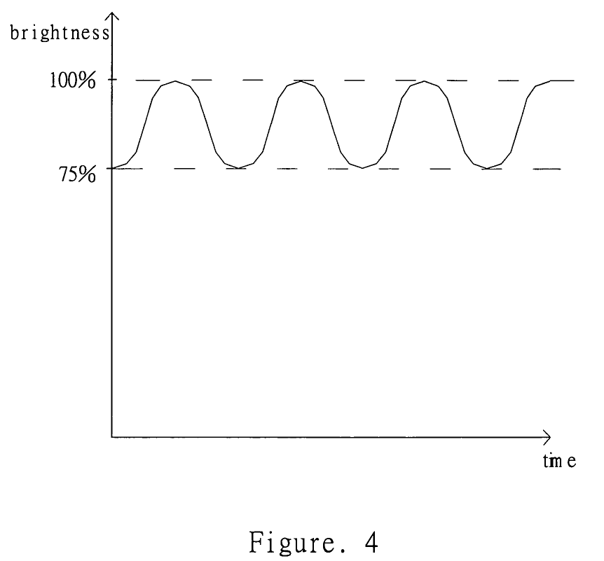

A preferred value of third threshold value obtained by the present inventor in lab is ⅓, which is shown as FIG. 4. While the range of brightness variance is from 70% to 100% (the greater brightness is 100%), it is tolerable range of the light sensor device (the present inventor use CMOS sensor to do the experiment). However, this number-value will has different value under with following different device at different process or skill. Therefore, the number of value needs to focus on the characteristic of different light sensor device to make it the best.

As for CCD, the measurement of environment brightness is obtained by measuring with the whole light sensor device. The measuring method of light source of environment is to use the whole light sensor device at different time points to obtain at least two measurement values of brightness environment. Then, in accordance with the determinative method mentioned above to determine what kind of light source of environment is. In other words, the user has to obtain at least two frames for determining light source environment.

However, some light sensor devices capture images by a plurality of sensing regions that composites the light sensor device sensing at different time points to obtain the whole image. CMOS sensor device, as an instance, which is divided liner into sensing a plurality of regions. The width of every liner sensing region is a (or above) pixel width, one frame is obtained by capturing an image with the liner sensing region one by another. Therefore, the present invention is to use such light sensor device as CMOS sensor device that the sensor regions thereof are sensed at different time points respectively to composite a frame. The light source of environment can be determined according to the sensed data at different time points during capturing a frame.

The main period artificial light source at present is 1/100 second or 1/120 second (alternating current (AC) with 50 Hz or 60 Hz). Therefore, while the light source of environment is determined as artificial light source, the length of time exposure of sensor can select as the integer times of 1/100 second or 1/120 second. However, this selection of the length of time exposure in accordance with the light sensor device of images instrument is only to be used as reference. For example, determinative method of a digital camera according to present invention is to select a length of time exposure, but if the brightness of light source of environment is short, then flash light or other assistant light source needs to be use, the length of time exposure needs to depend on the flash light or the status of using other assistant light source to adjust the appropriate time exposure.

The present invention also can use sensor to measure brightness variation of light source of environment at different time points to obtain the period of brightness variance environment. The length of time exposure is selected as the integer times of the measured brightness variation period. For instance, while shooting television, screen or other twinkled light source, its variance period may or may not be 1/100 or 1/120 second. Therefore, if light source of environment is determined as artificial light source will cause an inaccurate exposure problem if selecting the exposure time as 1/100 or 1/120 second. Therefore, we can select a more appropriate exposure time by using the period of brightness variance environment.

Furthermore, the present digital camera or digital video are usually coming with a LCD. The LCD can display the present image of what the sensor sensing (preview function). However, while the light source of environment is artificial light source or brightness of shooting object is periodic brightness variation, (in fact, the captured light by light sensor device is mainly the emitting light or reflective light by shooting object), its frequency for capturing images have not match with the frequency of light source of environment or the shooting object, then the brightness of images on the LCD will result in flickery phenomenon. Therefore, the present invention also can be used for determining light source of environment and for deciding the images capture instrument with monitor to execute preview function, determining the length of exposure period.

According to mention above, the present invention also provides a determinative method of main light source under the circumstance of the multi-light sources. The determinative method mention above comprising the steps of using at least two sensing regions of a light sensor device to measure at least two illumination values of light sources of environment at different time points, and determining a main light source of the environment according to the at least two illumination values.

The present invention further provides a method for determining main light source under the multi-light sources. The determinative method mention above comprising the steps of using a light sensor device to measure at least two illumination values of light sources of environment at different time points, and determining a main light source of the environment according to the at least two illumination values.

Therefore, the method using of the present invention, can determine whether a brightness variance of the light source of environment can be tolerable variance or not, then using it as a reference of selective time exposure. Moreover, the light sensor device is accordance with the time exposure to capture images data to the monitor of images capture instrument. This can make the images flicker-free displaying on the monitor.

Although specific embodiments have been illustrated and described, it will be obvious to those skilled in the art that various modifications may be made without departing from what is intended to be limited solely by the appended claims.

1. The main illuminant determinative method under multi-light environment, comprising the steps of:
using at least two sensing regions of a light sensor device to measure at least two illumination values of light source of environment at different time points, and determining a main light source of the environment according to said at least two illumination values.

2. The main illuminant determinative method under multi-light environment according to claim 1, wherein the light sensor device is CMOS sensor device.

3. The main illuminant determinative method under multi-light environment according to claim 2, wherein said main light source is determined as an artificial light source, a length of time exposure of said light sensor device is said integer times of 1/100 second or 1/120 second.

4. The main illuminant determinative method under multi-light environment according to claim 2, wherein said main light source is determined as a stable light source if a variance ratio of a difference between said at least two illumination values are smaller than a largest variance of a natural light source.

5. The main illuminant determinative method under multi-light environment according to claim 2, wherein said variance ratio of a difference said at least two illumination values is greater than said greatest value of a natural light source and greater than said smallest value of an artificial light source, then said light source of environment is determined as an artificial light source.

6. The main illuminant determinative method under multi-light environment according to claim 5, further comprising a step of determining a varying period according to said at least two illumination values.

7. The main illuminant determinative method under multi-light environment according to claim 2, wherein said main light source is determined as a stable light source if a variance ratio of a difference between said at least two illumination values are greater than said greatest variance of a natural light source and smaller than said smallest variance of an artificial value, and said difference of two illumination values with one of an illumination ratio of said two illumination values are smaller than a predetermining value.

8. The main illuminant determinative method under multi-light environment according to claim 2, wherein said main light source is determined as an artificial light source if a variance ratio of a difference between said at least two illumination values are greater than said greatest variance value of a natural light source and smaller than said smallest variance value of an artificial value, and said difference of two illumination values with a selective illumination ratio of two illumination values are greater than a predetermining value.

9. The main illuminant determinative method under multi-light environment according to claim 8, further comprising a step of determining a varying period according to said at least two illumination values.

10. The main illuminant determinative method under multi-light environment according to claim 1, wherein said light senor device is used for an captured image instrument, said images capture instrument come with a monitor, said light sensor device is to capture an image data according to said length of time exposure, then said monitor display an image in accordance with said image data.

11. The main illuminant determinative method under multi-light, environment comprising the steps of:
using a light sensor device to measure at least two illumination values of light source of environment at different time points; and
determining a main light source of the environment according to said at least two illumination values.

12. The main illuminant determinative method under multi-light environment according to claim 11, wherein said light sensor device is CCD.

13. The main illuminant determinative method under multi-light environment according to claim 12, wherein said main light source is determined as a stable light source if a variance ratio of a difference between said at least two illumination values are smaller than said largest variance of a natural light source.

14. The main illuminant determinative method under multi-light environment according to claim 12, wherein said main light source is determined as an artificial light source if a variance ratio of a difference between said at least two illumination values are greater than said greatest variance value of a natural light source and greater than said smallest variance value of an artificial light source.

15. The main illuminant determinative method under multi-light environment according to claim 12, wherein said main light source is determined as a stable light source if a variance ratio of a difference between said at least two illumination values are greater than said greatest variance value of a natural light source and smaller than said smallest variance value of an artificial value, and said different of two illumination values with one of an illumination ratio value under said two illuminations value are smaller than a predetermining value.

16. The main illuminant determinative method under multi-light environment according to claim 12, wherein said main light source is determined as an artificial light source if a variance ratio of a difference between said at least two illumination values are greater than said greatest variance value of a natural light source and smaller than said smallest variance value of an artificial value, and said difference of two illumination values with a selective illumination ratio value of two illuminations values are greater than a predetermining value.

17. The main illuminant determinative method under multi-light environment, comprising the steps of:
using a light sensor device to measure at least two illumination values of light source of environment at different time points; and
comparing a variance ratio of a difference between said at least two illumination values with a first threshold value;
comparing a variance ratio of a difference between said at least two illumination values with a second threshold value; and
comparing a variance ratio of a difference between said at least two illumination values with a third threshold value.

18. The main illuminant determinative method under multi-light environment according to claim 17, wherein said the light sensor device is CMOS sensor device.

19. The main illuminant determinative method under multi-light environment according to claim 17, wherein said main light source is determined as an artificial light source, a length of time exposure of said light sensor device is said integer times of 1/100 second or 1/120 second.

20. The main illuminant determinative method under multi-light environment according to claim 17, wherein said first threshold value is said greatest variance value of a natural light source.

21. The main illuminant determinative method under multi-light environment according to claim 17, wherein said second threshold value is said smallest variance value of an artificial light source.

22. The main illuminant determinative method under multi-light environment according to claim 17, wherein said third threshold value is determined according to said tolerable range of said light sensor device.
